(19) United States
(12) Patent Application Publication
(10) Pub. No.: US 2014/0016442 A1
(43) Pub. Date: Jan. 16, 2014

(54) Timer Systems And Methods Of Monitoring A Period Of Time With Respect To An Article

(71) Applicant: Mark Hoover, Spokane, WA (US)

(72) Inventor: Mark Hoover, Spokane, WA (US)

(21) Appl. No.: 13/545,845

(22) Filed: Jul. 10, 2012

(51) Int. Cl. G04F 10/00

(52) U.S. Cl. 368/109

(57) ABSTRACT

Timer systems and methods of monitoring a period of time with respect to an article are described. In one aspect, a timer system includes a timing device comprising circuitry configured to monitor a period of time, an attachment system coupled with the timing device and configured to attach the timing device to as associated article for which the period of time is to be monitored, and wherein the circuitry of the timing device is further configured to generate a human perceptible signal to convey information regarding the period of time being monitored with respect to the associated article.

### TECHNICAL FIELD

The present disclosure relates to timer systems and methods of monitoring a period of time with respect to an article.

### BACKGROUND

Many consumer items may be considered to be perishable or otherwise have useful lives for various finite lengths of time. The lengths of time may vary depending upon the items themselves and/or the conditions under which the items are stored. For example, some food products may be stored for longer periods of time in a freezer compared with refrigeration of the same food products. Other items, including non-edible items such as paint or chemicals, may also have fixed useful or effective lives. The lengths of the effective lives may be quite long for some products, for example, lasting months or even years. Accordingly, it may be difficult for consumers to recall how much time has passed since various products have been stored, opened or otherwise utilized.

At least some aspects of the disclosure are directed towards various apparatus and methods for assisting people with keeping track of the ages of various products. Other aspects are described below.

### BRIEF DESCRIPTION OF THE DRAWINGS

Example embodiments of the disclosure are described below with reference to the following accompanying drawings.

FIG. 1 is an illustrative representation of a timer system according to one embodiment.

FIG. 2 is an illustrative representation of a first side of an attachment system according to one embodiment.

FIG. 2A is an illustrative representation of a second side of the attachment system of FIG. 2.

FIG. 3 is an illustrative representation of a timing device according to one embodiment.

FIG. 4 is a block diagram of circuitry of a timing device according to one embodiment.

FIG. 5 is an illustrative representation of a first attachment arrangement of an attachment system according to one embodiment.

FIG. 6 is an illustrative representation of a second attachment arrangement of an attachment system according to one embodiment.

### DESCRIPTION

This disclosure is submitted in furtherance of the constitutional purposes of the U.S. Patent Laws “to promote the progress of science and useful arts” (Article 1, Section 8).

According to one embodiment, a timer system comprises a timing device comprising circuitry configured to monitor a period of time, an attachment system coupled with the timing device and configured to attach the timing device to an associated article for which the period of time is to be monitored, and wherein the circuitry of the timing device is further configured to generate a human perceptible signal to convey information regarding the period of time being monitored with respect to the associated article.

According to an additional embodiment, a timer system comprises a timing device comprising monitoring circuitry configured to monitor a period of time, display circuitry configured to display information regarding the period of time being monitored, interface circuitry configured to receive user inputs which define the period of time and initiate monitoring of the period of time, and alarm circuitry configured to generate an alarm signal as a result of the monitoring detecting passage of the period of time, an attachment system comprising a plurality of attachment arrangements individually configured to attach the timing device to an associated article for which the period of time is to be monitored, wherein a first of the attachment systems comprises a reel comprising a retractable lanyard which is configured to be pulled outward from the reel and to be placed around the associated article to attach the timing device to the associated article during the monitoring of the period of time, and wherein a second of the attachment systems comprises a magnet configured to magnetically attach the timing device to the associated article during the monitoring of the period of time, and a removable coupling which is configured to removably couple the attachment system with the timing device.

According to another embodiment, a method of monitoring a period of time with respect to an article comprises providing a timer system comprising a timing device and an associated attachment system, using the attachment system, attaching the timing device to an associated article for which a period of time is to be monitored, initiating the timing device to begin monitoring of the period of time with respect to the associated article, using the timing device, monitoring the period of time after the initiating, and using the timing device, generating a human perceptible signal to convey information regarding the period of time being monitored with respect to the article as a result of the monitoring.

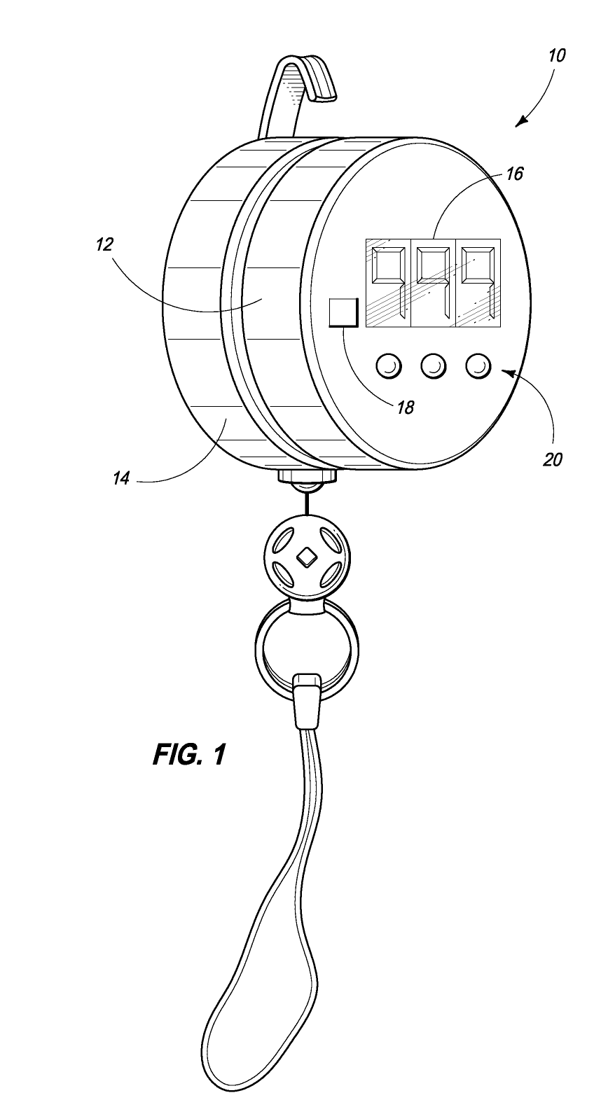

Referring to FIG. 1, one embodiment of a timer system 10 is shown. The illustrated example embodiment of timer system 10 includes a timing device 12 and an attachment system 14. The timer system 10 is lightweight and portable in one implementation and may be easily attached to an associated article using attachment system 14 as discussed in detail below. The timing device 12 is configured to monitor a period of time with respect to an associated article. The timing device 12 is relatively compact in one embodiment having a diameter of approximately 30 mm and a width of approximately 12 mm.

In some embodiments, timer system 10 may be utilized to monitor associated articles which are frozen and may be stored within a freezer. Accordingly, timer system 10 is configured to monitor associated articles in freezing temperatures in at least one embodiment. For example, timing device 10 may operate at freezing temperatures of approximately −18 degrees Celsius in one embodiment.

Timer system 10 is configured to monitor a period of time with respect to the associated article and to inform a consumer of time information regarding the associated article as a result of the monitoring. In some illustrative examples, the timer system 10 may perform the following different operations with respect to monitoring a period of time with respect to an article: monitoring a period of time which has passed since an associated article has been placed in storage, monitoring a period of time which has passed since the associated article has been opened, monitoring present day and time information with respect to a programmed or specified day and time in the future which defines the period of time, and monitoring an amount of time remaining of a specified or programmed amount of time. In some embodiments, the timing device 12 may generate human perceptible signals as a result of the monitoring and may convey information regarding the period of time being monitored with respect to the article.

Timing device 12 may be implemented as a digital timer which is configured to monitor the period of time with respect to an associated article in one configuration. The illustrated timing device 12 may generate one or more human perceptible signals to convey information regarding the period of time being monitored with respect to an associated article. For example, the timing device 12 may include a display 16, such as an LCD display, configured to visually display information for observation by a user, and a speaker 18 configured to generate audible signals, such as alarm signals. The timing device 12 may also include one or more buttons 20 to permit a user to program the timing device 12, for example, to define the period of time to be monitored with respect to an associated article. The visual and/or audible signals may be generated to inform people of information regarding the period of time being monitored with respect to the associated article in one embodiment.

In one example, the user may initiate the timing device 12 to begin monitoring a period of time when an associated article is placed in storage, opened or other desired starting point. As discussed below, the timer system 10 may be attached to the associated article to be monitored. After an initial programming or reset, the timing device 12 may continuously monitor the period of time which has passed since the monitoring was initiated and/or monitor a remaining amount of a defined period of time, and provide information regarding the monitoring of the period of time.

Upon storage, opening or other point of reference of an associated article, the user may enter a defined period time and the timing device 12 may monitor the time and inform the user when the defined period of time has passed or elapsed. In one example, timing device 12 is a countdown timer which may count down a defined period of time, for example, up to 999 days as programmed by a user. For example, the user may program the defined period of time corresponding to a useful life of the associated article or product. If an associated article has been opened, the user may initiate the timing device 12 to begin monitoring the period of time which has passed since the article has been opened or used. Once monitoring is initiated, the timing device 12 starts to count down from the programmed period of time.

In one embodiment, the user may view the display 16 which may depict information regarding the period of time being monitored, for example, a number of days, weeks, months and/or years which remain in the monitored period of time.

In another example, the timing device 12 may count up after the monitoring has been initiated by the user. The display 16 may depict a period of time which has passed or elapsed since the monitoring of the period of time was initiated.

In another example, the user may input a date and/or time in the future, and the timing device 12 may access current date and/or time information. The timing device may monitor the current date and/or time with respect to the programmed future date and/or time to monitor the period of time with respect to an associated article. The display 16 may also depict the current date and/or time as well as the programmed future date and/or time. Other embodiments are possible for defining a period of time with respect to an associated article and monitoring the period of time.

As a result of the monitoring of the period of time, the timing device 12 may generate human perceptible signals in one embodiment. In one embodiment, the timing device 12 may generate visual signals or information (e.g., blinking of the display 16 or light source or display of digital information using the display 16) and/or audible alarms using the speaker 18 as a result of the monitoring and to inform a user of the monitoring including, for example, indicating a present status of the period of time being monitored and when the period of time being monitored has passed.

In one embodiment, the timing device 12 may generate the signals as a result of various monitored events. For example, the timing device 12 may generate visual and/or audible signals when the timing device 12 has counted down or up a defined period of time or a programmed date and/or time in the future has been reached. In one more specific example, if the period of time being monitored is six months, the timing device 12 begins monitoring the period of time upon programming, and may thereafter generate a visual and/or audible signal once six months have passed to inform the user of the passage of the defined period of time.

The user may take appropriate action as a result of the generated signals, such as using the associated article, or perhaps discarding the associated article. In one embodiment, the generated signals continue until a user ceases the signals by using an appropriate button 20.

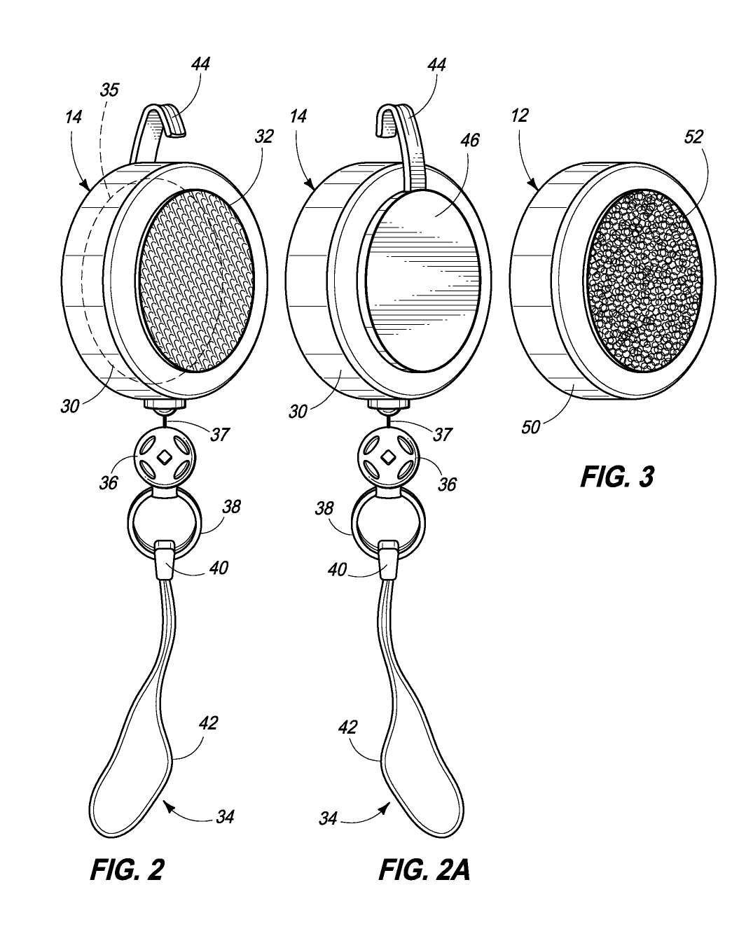

Referring to FIG. 2, an example embodiment of attachment system 14 is shown. Attachment system 14 is configured to attach the timer system 10 to an associated article to be monitored. Attachment system 14 shown in FIG. 2 is configured to attach the timer system 10 to different associated articles in a plurality of different ways using different attachment arrangements although other attachment systems 14 may only include a single attachment arrangement for attaching the timing device 12 to an associated article.

In one implementation, attachment system 14 includes a housing 30 of a suitable material, such as plastic, and a hook-and-loop fastener 32 (e.g., Velcro) may be provided upon a surface of the housing 30. The attachment system 14 has a compact size in one implementation where the housing 30 is approximately 32 mm in diameter and approximately 10 mm wide. The fastener 32 has a diameter of approximately 20 mm in one embodiment. The timing device 12 may also have a corresponding hook-and-loop fastener 52 as shown in FIG. 3 and the fasteners 32, 52 together provide a removable coupling of the timing device 12 and the attachment system 14 with one another in one embodiment. In other embodiments, the timing device 12 and attachment system 14 may be formed within a single, integral housing.

In one embodiment, attachment system 14 includes a first attachment arrangement in the form of a retractable lanyard 34 for attaching the timer system 10 to an associated article. A reel 35 may be provided within the interior of housing 30 and may be spring-loaded to retract the lanyard 34 and string 37 into the housing 30 when not in use. The lanyard 34 in the illustrated configuration is attached to a string 37 of suitable material, such as nylon, and which has an approximate length of 30″ to provide attachment to a wide range of associated articles. The user may pull the lanyard 34 and string 37 out of the housing 30 for use and the reel 35 retracts the lanyard 34 and string 37 into the housing 30 when not in use.

In the illustrated example configuration, the string 37 may be passed through an aluminum ball 36 having a diameter of approximately 9 mm and tied to a split ring 38 having a diameter of approximately 10 mm. The ball 36 facilitates grasping and pulling of the lanyard 34 and also prevents the reel 35 from retracting the entirety of the lanyard 34 internally of the housing 30.

A hollow or solid metal ferrule 40 which is approximately 7 mm long and 3 mm in diameter is attached to the split ring 38. A second string 42 of suitable material, such as nylon, may be tied to the ferrule 40 to create a string-loop. The string 42 may have a length of approximately 120 mm providing a loop with a diameter of approximately 33 mm.

In one embodiment, a hook 44 of suitable material, such as metal (e.g., brass), may be attached to the housing 30 and configured to receive and retain the loop formed by string 42 when the lanyard 34 is wrapped around an associated article. The spring-bias of the reel 35 retracts the lanyard 34 after being wrapped around an associated article to attach the timer system 10 to the associated article.

In one example configuration, the hook 44 has an overall length of 22 mm when straightened with approximately 10 mm of the length having a width of approximately 10 mm and the width of the remaining portion of the length is approximately 4 mm. The wider portion of the hook 44 may be glued or otherwise attached to the housing 30. The remainder of the hook 44 extends outward from the housing 30 approximately 8 mm before bending approximately 125 degrees back towards the housing 30 and leaving an opening of about 4 mm with respect to the housing 30. Other configurations or embodiments are possible.

Referring to FIG. 2A, a side of the housing 30 of the attachment system 14 is shown which is opposite to the side of the housing 30 shown in FIG. 2. In one embodiment, a magnet 46 is attached to the housing 30 providing a second attachment arrangement for attaching the timer system 10 to articles. More specifically, the magnet 46 may be used to attach the timer system 10 to associated articles which include metal, for example, a metal lid of a jar. The magnet 46 has a width of approximately 2 mm and a diameter of approximately 28 mm in one configuration. The magnet 46 could also be used to attach the timer system 10 to a refrigerator or other metal surface for storage.

Referring to FIG. 3, a side of a housing 50 of the timing device 12 is shown which is opposite to the side of the timing device 12 shown in FIG. 1. A hook-and-loop fastener 52 having a diameter of approximately 20 mm may be attached to the side of the housing 50 for removable attachment of the timing device 12 to the attachment system 14 as discussed above in one embodiment. Providing a removable coupling of the timing device 12 and attachment system 14 permits the components to be used separately, if desired, or together with one another as described herein as the timer system 10. In another embodiment, a magnet may be used instead of the hook-and-loop fastener for the removable coupling of the timing device 12 and attachment system 14. Other attachment methods are possible.

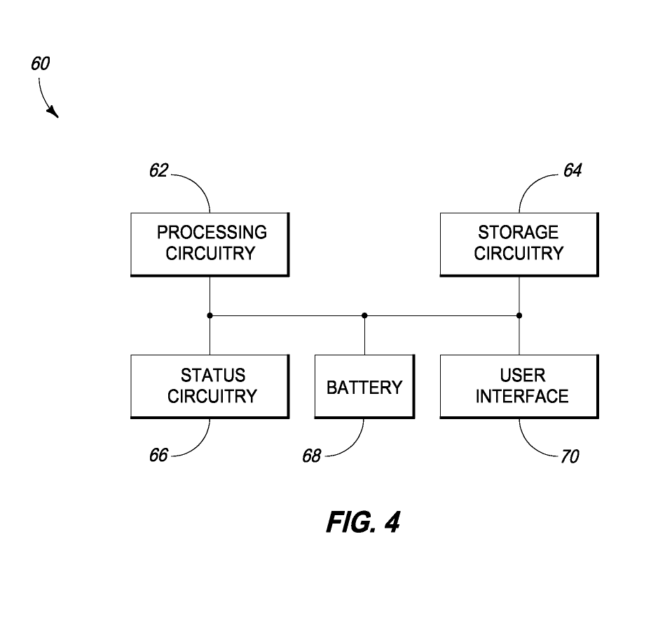

Referring to FIG. 4, one embodiment of circuitry 60 of the timing device 12 is shown. In the illustrated example embodiment, circuitry 60 includes processing circuitry 62, storage circuitry 64, status circuitry 66, a battery 68, and a user interface 70. Other embodiments are possible including more, less and/or alternative components.

In one embodiment, processing circuitry 62 is arranged to process data, control data access and storage, issue commands, and control other desired operations of the timing device 12. Processing circuitry 62 is configured to monitor a period of time with respect to an associated article and may be referred to as monitoring circuitry. Processing circuitry 62 may implement counting up or down operations as described herein to implement example monitoring. Processing circuitry 62 may also be used to count time up or down to operate as a reminder to a user perhaps without any association to an another article.

As a result of the monitoring, the processing circuitry 62 may control generation of human perceptible signals, for example, using the status circuitry 66. For example, the processing circuitry 62 may monitor a defined period of time and control the generation of one or more alarm signals as a result of the elapsing of the defined period of time being monitored. In another example, the processing circuitry 62 may maintain and monitor date and time information and control the generation of one or more alarm signals as a result of present date and time information matching a programmed date and time. Other embodiments are possible for monitoring a period of time with respect to an associated article and generating one or more human perceptible signal as a result of the monitoring.

Processing circuitry 62 may comprise circuitry configured to implement desired programming provided by appropriate computer-readable storage media in at least one embodiment. For example, the processing circuitry 62 may be implemented as one or more processor(s) and/or other structure configured to execute executable instructions including, for example, software and/or firmware instructions. Other example embodiments of processing circuitry 62 include hardware logic, PGA, FPGA, ASIC, state machines, and/or other structures alone or in combination with one or more processor(s). These examples of processing circuitry 62 are for illustration and other configurations are possible.

Storage circuitry 64 is configured to store programming such as executable code or instructions (e.g., software and/or firmware), electronic data, databases, image data, or other digital information and may include computer-readable storage media. At least some embodiments or aspects described herein may be implemented using programming stored within one or more computer-readable storage medium of storage circuitry 64 and configured to control appropriate processing circuitry 62. In one embodiment, the storage circuitry 64 may store information regarding a defined period of time and/or date and time to be monitored with respect to an associated article.

The computer-readable storage medium may be embodied in one or more articles of manufacture which can contain, store, or maintain programming, data and/or digital information for use by or in connection with an instruction execution system including processing circuitry 62 in one embodiment. For example, computer-readable storage media may be non-transitory and include any one of physical media such as electronic, magnetic, optical, electromagnetic, infrared or semiconductor media. Some more specific examples of computer-readable storage media include, but are not limited to, a portable magnetic computer diskette, such as a floppy diskette, a zip disk, a hard drive, random access memory, read only memory, flash memory, cache memory, and/or other configurations capable of storing programming, data, or other digital information.

Status circuitry 66 may include the display 16 configured to depict visual signals or information such as alarm signals and the amount of time of the period of time being monitored which has elapsed (or remains), the present date/time or a date/time in the future when an alarm will be generated. Status circuitry 66 may also include speaker 18 configured to generate audible signals, for example, indicating that the period of time being monitored with respect to an associated article has elapsed.

Battery 68 is configured to supply electrical power to the circuitry of the timing device 12. Examples of battery 68 include a coin/button-type battery and which may operate in temperatures below freezing (e.g., −18 degrees Celsius or colder) in some embodiment. Battery 68 may be a Lithium-manganese type which may provide sufficient energy for an extended period of time (e.g., one year or more). An example battery 68 may be approximately 24 mm in diameter and have a width of approximately 5 mm. Another example of battery 68 is a cylindrical Lithium battery.

User interface 70 may be also referred to as interface circuitry which is configured to interact with a user, and may for example, include buttons 20 which are configured to receive inputs from the user. For example, the user may program a desired defined period of time to be monitored with respect to an associated article, such as a specified amount of time or a moment in time in the future. The monitoring of the period of time may be initiated by a user input and used to trigger an alarm with respect to the associated article. The user interface 70 may also be used to silence an emitted alarm by timing device 12. User interface 70 may be configured differently in other embodiments.

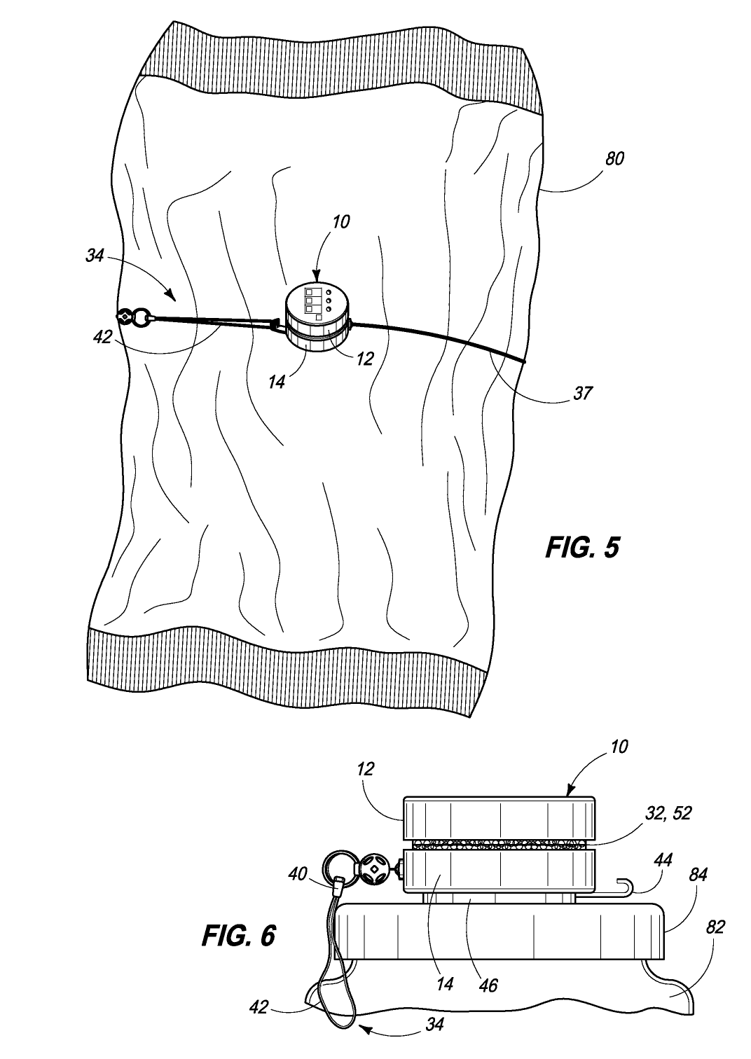

Referring to FIG. 5, the lanyard 34 is utilized as a first attachment arrangement for attaching the timer system 10 to an associated article 80, such as a bag containing a perishable food product. The lanyard 34 and string 37 may be drawn out of the housing of the timer system 10, and the lanyard 34 placed around the package of the article 80, and coupled with the hook 44. Thereafter, the spring-bias of the reel may retract the string 37 of the lanyard 34 attaching the timer system 10 to the article 80. In some embodiments, the lanyard 34 may be utilized to simultaneously attach the timer system 10 to a plurality of associated articles to be monitored.

Referring to FIG. 6, the magnet 46 is utilized as a second attachment arrangement for attaching the timer system 10 to a metal lid 84 of an associated article 82. For example, the magnet 46 may be placed adjacent to a metal lid 84 or other metal surface of the article 82 to form a magnetic coupling which removably attaches the timer system 10 to the article 84. The magnet 46 may also be used to attach the timer system 10 to other metal surfaces or objects, such as a refrigerator door for example for storage.

Although the described example attachment system 14 comprises a plurality of different attachment arrangements, only one of the different attachment arrangements may be selected and used to attach the timer system 10 to a given associated article as shown in the examples of FIGS. 5-6. Following the attachment of the timer system 10 to the respective article, the timing device 12 may monitor a period of time with respect to the article as described herein.

The timer system 10 of the present disclosure may be utilized in various applications including being used to inform people of articles which may be at or approaching the end of their useful lives. The timer system 10 may be used with different articles which may have different lifespans and which may expire at different moments in time in the future. The timer system 10 may help people use articles before they have expired, inform people which articles which have expired and should be removed or discarded, or for other purposes, such as informing people of a time as a reminder to do something.

Further, aspects herein have been presented for guidance in construction and/or operation of illustrative embodiments of the disclosure. Applicant(s) hereof consider these described illustrative embodiments to also include, disclose and describe further inventive aspects in addition to those explicitly disclosed. For example, the additional inventive aspects may include less, more and/or alternative features than those described in the illustrative embodiments. In more specific examples, Applicants consider the disclosure to include, disclose and describe methods which include less, more and/or alternative steps than those methods explicitly disclosed as well as apparatus which includes less, more and/or alternative structure than the explicitly disclosed structure

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect.

What is claimed is:

1. A timer system comprising:
a timing device comprising circuitry configured to monitor a period of time;
an attachment system coupled with the timing device and configured to attach the timing device to an associated article for which the period of time is to be monitored; and
wherein the circuitry of the timing device is further configured to generate a human perceptible signal to convey information regarding the period of time being monitored with respect to the associated article.

2. The system of claim 1 wherein the attachment system comprises a plurality of different attachment arrangements which are individually configured to attach the timing device to the associated article.

3. The system of claim 2 wherein one of the different attachment arrangements comprises a reel and a retractable lanyard.

4. The system of claim 3 wherein another of the different attachment arrangements comprises a magnet.

5. The system of claim 1 wherein the circuitry of the timing device comprises display circuitry configured to generate the human perceptible signal comprising a visible signal which includes information indicative of the period of time being monitored with respect to the article.

6. The system of claim 1 wherein the circuitry of the timing device comprises alarm circuitry configured to generate the human perceptible signal comprising an audible alarm signal.

7. The system of claim 1 wherein the attachment system and the timing device are configured to be removably coupled with one another.

8. The system of claim 1 further comprising a user interface configured to access user inputs which define the period of time to be monitored with respect to the associated article and status circuitry configured to generate the human perceptible signal as a result of a passing of the defined period of time.

9. The system of claim 1 wherein the circuitry of the timing device is configured to monitor the period of time corresponding to an amount of time since the associated article was opened.

10. The system of claim 1 wherein the circuitry of the timing device is configured to monitor the period of time corresponding to an amount of time since the associated article has been stored.

11. A timer system comprising:
a timing device comprising:
monitoring circuitry configured to monitor a period of time;
display circuitry configured to display information regarding the period of time being monitored;
interface circuitry configured to receive user inputs which define the period of time and initiate monitoring of the period of time; and
alarm circuitry configured to generate an alarm signal as a result of the monitoring detecting passage of the period of time;
an attachment system comprising a plurality of attachment arrangements individually configured to attach the timing device to an associated article for which the period of time is to be monitored, wherein a first of the attachment systems comprises a reel comprising a retractable lanyard which is configured to be pulled outward from the reel and to be placed around the associated article to attach the timing device to the associated article during the monitoring of the period of time, and wherein a second of the attachment systems comprises a magnet configured to magnetically attach the timing device to the associated article during the monitoring of the period of time; and
a removable coupling which is configured to removably couple the attachment system with the timing device.

12. A method of monitoring a period of time with respect to an article comprising:
providing a timer system comprising a timing device and an associated attachment system;
using the attachment system, attaching the timing device to an associated article for which a period of time is to be monitored;
initiating the timing device to begin monitoring of the period of time with respect to the associated article;
using the timing device, monitoring the period of time after the initiating; and
using the timing device, generating a human perceptible signal to convey information regarding the period of time being monitored with respect to the article as a result of the monitoring.

13. The method of claim 12 wherein the attachment system comprises a plurality of different attachment arrangements which are individually configured to attach the timing device to the associated article, and further comprising selecting one of the different attachment arrangements corresponding to the associated article to which the timer system is to be utilized.

14. The method of claim 12 wherein the attaching comprises:
pulling a retractable lanyard from a reel of the attachment system; and
providing the lanyard around the associated article.

15. The method of claim 12 wherein the attachment system comprises a magnet, and the attaching comprises establishing a magnetic coupling of the magnet with metal of the associated article.

16. The method of claim 12 wherein the generating the human perceptible signal comprises displaying information regarding the period of time being monitored with respect to the article.

17. The method of claim 12 wherein the generating the human perceptible signal comprises generating an audible alarm signal.

18. The method of claim 12 further comprising accessing a user input which defines the period of time.

19. The method of claim 18 wherein the monitoring comprises monitoring for the passage of the defined period of time, and the generating comprises generating the human perceptible signal comprising an alarm signal as a result of the passage of the period of time.

20. The method of claim 12 wherein the monitoring comprises monitoring the period of time corresponding to an amount of time after the initiating with respect to a defined period of time.
